(19) United States
(12) Patent Application Publication
(10) Pub. No.: US 2026/0168318 A1
(43) Pub. Date: Jun. 18, 2026

(54) RESILIENT, FORCE-ABSORBING CLOSURES AND METHODS

(71) Applicant: SAM AUSTIN, Beaverton, OR (US)

(72) Inventor: SAM AUSTIN, Beaverton, OR (US)

(21) Appl. No.: 19/436,798

(22) Filed: Dec. 30, 2025

Related U.S. Application Data
(63) Continuation-in-part of application No. 17/929,727, filed on Sep. 5, 2022, now abandoned.

(51) Int. Cl. E06B 5/10

(52) U.S. Cl. CPC E06B 5/103

(57) ABSTRACT

A resilient, force-absorbing closure for structural openings comprises at least one anchoring panel configured to be secured to a structure opening and one or more floating panels elastically coupled to the anchoring panel via one or more internal elastic couplers. In a closed state, the anchoring panel is restrained while the cooperative arrangement of the floating panel and elastic coupler provides at least one translational degree of freedom to the floating panel. In response to an impact force, the floating panel translates relative to the anchoring panel, elastically deforming the coupler to elongate collision duration and reduce impact forces. Embodiments include multi-panel systems with synchronized or independent floating panels on opposite sides of the anchoring panel, and hybrid constructions utilizing transparent, blast-resistant glass. The system may further include interlocking stoppers to limit translation and integrated damping materials to diminish post-impact vibrations.

### CROSS-REFERENCE TO RELATED APPLICATIONS

This application is a continuation-in-part of U.S. application Ser. No. 17/929,727 naming the same inventor, filed in the USPTO on Sep. 5, 2022, the entirety of which is incorporated herein by reference.

### BACKGROUND

The invention relates to fixed and/or movable closures such as windows, doors, gates, and the like, and more particularly to robust closures that can withstand impacts from security threats and also by flying debris in extreme weather events, and methods for making same.

Building closures like windows, doors, gates, and the like play an important role in protecting life and property. For example, during a burglary, an intruder may use a sledge hammer to break the door open. In addition to weather events like tornados and high winds, other loads like blasts, explosions, implosions, ballistics, accidents, etc. can apply dynamic loadings on closures. Damage to a closure under such loadings can range from easily repairable minor structural damage to catastrophic structural failure.

Industry standards for high-impact doors ensure they can withstand impacts from forced entry attempts and also flying debris during extreme wind events likely to be encountered in certain regions. For example, US Department of State SD-STD-01.01 specifies forced-entry and ballistic resistance requirements for structural systems such as doors, windows, and related anchoring hardware. It defines testing protocols, including simulated assaults, and assigns resistance levels based on timed forced-entry performance to certify products for use in high-security environments. American Society for Testing and Materials (ASTM) E1996 standard is another standard that tests the resistance of windows and doors to windborne debris during hurricanes. It specifies the test methods for impact resistance for different missile level ratings for hurricane resistant doors. For a door to be considered hurricane-resistant in most coastal areas, it must pass the ASTM E1996 standard ‘Large Missile Impact Test’ that requires the door to withstand the impact of a 9-pound 2×4 lumber propelled end-on at a speed of 50 feet per second (approximately 34 mph). To pass this test, the missile cannot penetrate the door or knock it off its hinges.

Achieving closures that will meet industry standards can be challenging for engineers and designers. One challenge is selecting and integrating materials that can withstand the high-impact forces generated by impacting objects without permanently deforming, breaking, penetrating the door or knocking it off its hinges. In that regard, two material properties are particularly important. The first is stiffness (e.g. flexural modulus), which determines resistance of a material to elastic deformation. The second is strength (e.g. flexural strength), which determines resistance of a material to damage and permanent deformation.

Conventional approaches to achieving doors that will pass industry standard tests like ASTM E1996 standard rely on materials having a relatively high stiffness as well as a relatively high strength rating. For example, some conventional high-impact rated doors rely on heavy-gauge steel skins over a solid core, which can comprise foam or honeycomb, with internal reinforcements. These doors have excellent impact resistance. However, they have a disadvantage in that heavy-gauge steel makes these doors heavy. They can be difficult to install, often requiring professional assistance. Their weight necessitates reinforced hinges and door frames to support the load without sagging or eventual structural damage. Though strong, steel can dent upon sharp impact and these dents are very difficult to repair cosmetically. The entire door panel often needs replacement to restore its aesthetic appeal.

Other conventional high-impact rated doors employ durable fiberglass skins and a solid polyurethane foam core. Unlike steel, fiberglass is highly resistant to minor dents and dings. However, high-impact fiberglass doors are often significantly more expensive than standard steel doors due to specialized materials, complex manufacturing processes, and rigorous testing requirements. Also, the high stiffness that makes them rigid makes them prone to crack or fracture under concentrated high-impact loads.

In view of the foregoing, it would be desirable to have closures that meet or exceed industry standards for high-impact ratings. In some cases, conventional closures may meet industry standards for a high-impact rating at one level, but may nonetheless fail to meet industry standards for a higher impact rating. Methods for improving the impact resistance capabilities of conventional closures to qualify them for higher impact ratings would be desirable. It would be desirable to have methods for improving impact-resistant properties of existing closures to meet criteria for high-impact closures, without extensive modification of the existing closures.

It would further be advantageous to have closures and methods that can absorb impact forces to meet industry standards for the high-impact rating of a target industry standard, while maintaining their dimensional stability. It would be advantageous to have closures and methods that can meet industry standards for high-impact ratings without transferring forces generated in a high-impact event to their support structures and anchoring hardware.

It would further be advantageous to have methods for achieving lighter, less bulky and less expensive high-impact closures that are nonetheless capable of meeting industry standards for high-impact ratings without relying on heavy duty hinges and latches. It would further be advantageous to have closures that can achieve industry standard high-impact ratings and which are relatively simple to produce and assemble.

### SUMMARY

The disclosure provides resilient, force-absorbing closures and methods that can provide any or all of the foregoing advantages and benefits, as well as many additional benefits and advantages that will become readily apparent to those of ordinary skill upon reading the detailed description below with reference to the appended drawing figures.

### BRIEF DESCRIPTION OF THE DRAWING FIGURES

FIG. 1A is an exploded isometric view of an example impact-robust closure according to the disclosure;

FIG. 1B is an isometric view of the example impact-robust closure illustrated in FIG. 1A in an ‘unloaded’ (‘resting’, ‘natural’) state of the closure;

FIG. 1C is a cross-sectional view taken along line 1-1 of the example impact-robust closure illustrated in FIG. 1B;

FIG. 1D is an enlarged view of the encircled portion 1 of the example impact-robust closure illustrated in FIG. 1C in an unloaded state of the closure;

FIG. 1E is an enlarged view of the encircled portion 1 of the example impact-robust closure illustrated in FIG. 1C in a loaded state;

FIG. 2A is an exploded isometric view of an example impact-robust closure according to the disclosure;

FIG. 2B is an isometric view of the example impact-robust closure illustrated in FIG. 2A in an unloaded state of the impact-robust closure;

FIG. 2C is a cross-sectional view taken along line 2-2 of FIG. 2B in an unloaded state of the impact-robust closure;

FIG. 2D is an enlarged view of the encircled portion 2 of the example impact-robust closure illustrated in FIG. 2C in an unloaded state of the impact-robust closure;

FIG. 2E is an enlarged view of the encircled portion 2 of the example impact-robust closure illustrated in FIG. 2C in a position responsive to application of an impact force;

FIG. 3A is a pictorial diagram illustrating example applications for the closures disclosed herein;

FIG. 3B is a pictorial diagram illustrating a resilient, force-absorbing closure comprising a door;

FIG. 4A is an isometric view of an example resilient, force-absorbing closure from an interior of an enclosed space according to the disclosure;

FIG. 4B is an isometric view of the example resilient, force-absorbing closure of FIG. 4A from an exterior of the enclosed space according to the disclosure;

FIG. 5A is a cross-sectional top view of a portion of a hinge jamb side of the example resilient, force-absorbing closure illustrated in FIGS. 4A 4B;

FIG. 5B is a cross-sectional top view of a portion of a hinge jamb side in an alternative implementation of the example resilient, force-absorbing closure 1000;

FIG. 5C is an isometric view of an alternative implementation of the example resilient, force-absorbing closure 1000;

FIG. 5D is an isometric, cross-sectional top view of a portion of a latch jamb side of the example closure illustrated in FIG. 5C;

FIG. 6 is an exploded isometric view of a portion of a latch jamb side of an example closure according to the disclosure;

FIG. 7 is an exploded isometric, cross-sectional top view of a portion of a latch jamb side of an example closure according to the disclosure;

FIG. 8A is an isometric, cross-sectional top view of a portion of a latch jamb side of an example closure in an unloaded state according to the disclosure;

FIG. 8B is an isometric, cross-sectional top view of a portion of the latch jamb side of the example closure illustrated in FIG. 8A in a loaded state according to the disclosure;

FIG. 9A is a cross-sectional top view of a portion of a latch jamb side of an example closure in an unloaded state according to the disclosure;

FIG. 9B is a cross-sectional top view of a portion of the latch jamb side of an example closure in a loaded state according to the disclosure;

FIG. 10A is a cross-sectional top view of a portion of a latch jamb side of an example closure in an unloaded state according to the disclosure;

FIG. 10B is a cross-sectional top view of a portion of the latch jamb side of an example closure in a loaded state according to the disclosure;

FIG. 11 is a cross-sectional top view of a portion of an example resilient, force-absorbing closure in an unloaded state according to the disclosure;

FIG. 12A is an isometric, cross-sectional top view of an example closure disposed within a frame according to the disclosure;

FIG. 12B shows a cross-sectional top view of a portion of the latch jamb side of the example closure illustrated in FIG. 12A in an unloaded state;

FIG. 12C shows a cross-sectional top view of a portion of the latch jamb side of the example closure illustrated in FIG. 12A in a loaded state;

FIG. 13A is an isometric, cross-sectional top view of an alternative implementation of the example resilient, force-absorbing closure 1000;

FIG. 13B is a cross-sectional top view of the example closure illustrated in FIG. 13A;

FIG. 14A is a cross-sectional top view of a portion of an alternative implementation of the example resilient, force-absorbing closure 1000 in an unloaded state;

FIG. 14B is a cross-sectional top view of a portion of the example resilient, force-absorbing closure illustrated in FIG. 14A in a loaded state; and

FIGS. 15A 15B 15C 15D are cross-sectional top view of a portion of an example resilient, force-absorbing closure, showing example methods for attaching spring type elastic couplers to panels of example closures according to the disclosure.

### DETAILED DESCRIPTION

### Definitions

Unless explicitly defined otherwise herein, the term ‘panel’ is intended to encompass within its meaning, the terms ‘slab’ and ‘leaf’.

The terms ‘impact receiver’ and ‘floating panel’ may be used interchangeably herein.

The terms ‘impact reducer’ and ‘elastic coupler’ may be used interchangeably herein.

The terms ‘backing’ and ‘anchoring panel’ may be used interchangeably in this specification to refer to a panel that is configured to be anchored to a structure such as a door frame by anchoring hardware such as pivots, wheels with tracks, hinges and latches. Unless explicitly stated otherwise, the term ‘panel’ generally refers to a structural panel element and does not necessarily include the associated anchoring hardware.

The terms ‘coupler’ as used herein may refer to any part of a closure that functions to keep the impact receiver, the impact reducer, and the backing in alignment. Part of a closure that guides the impact receiver to remain in alignment when the impact receiver is displaced towards the impact reducer may be referred to herein as a ‘joint’.

According to the disclosure, a ‘floating panel’ refers to a panel that is configured to be substantially free from rigid anchoring to a frame or to a structure, and having one translational degree of freedom relative to the anchoring panel in response to an applied force.

The embodiments described herein are provided by way of example only and are not intended to limit the scope of the invention. As used herein, the terms ‘comprising’, ‘including,’ and ‘having’ are open-ended and do not exclude additional elements or steps. Unless explicitly stated otherwise, any reference to relative positions, orientations, directions, dimensions, shapes, materials, or configurations of components is made solely for purposes of illustration. References to specific directions, including but not limited to the x-, y-, and z-axes, are provided for convenience of explanation and do not limit the orientation of the closure in use. As used herein, the term “closure” refers to doors, windows, gates, and similar barriers associated with an opening, whether fixed or movable, and whether in an open, closed, or intermediate state. The closure may be installed in any orientation consistent with its intended function. Unless expressly stated otherwise, the figures are not drawn to scale, and relative dimensions and proportions shown in the figures are exemplary only. Features described in connection with one embodiment may be combined with features of the same or other embodiments in any suitable manner. For example, some closure can have different number, arrangement, and configuration of panels, elastic couplers, springs, foams, stoppers, joints, and attachment mechanisms may be varied without departing from the spirit and scope of the disclosure. Impact forces may be generated by solid objects, as well as by gases or liquids. As used herein, the term “door hardware” is not limited to locks, latches, hinges, or other conventional securing or pivoting components. Rather, door hardware may include any mechanical, electromechanical, or structural component associated with the support, movement, positioning, guidance, or operation of a door or door assembly. By way of non-limiting example, door hardware may additionally or alternatively include rollers, wheels, tracks, rails, guides, sliders, bearings, dampers, closers, stops, seals, sensors, actuators, or combinations thereof. Such components may be configured to enable swinging, sliding, rolling, folding, telescoping, or otherwise controlled movement of the door relative to a frame, wall, floor, ceiling, or other supporting structure.

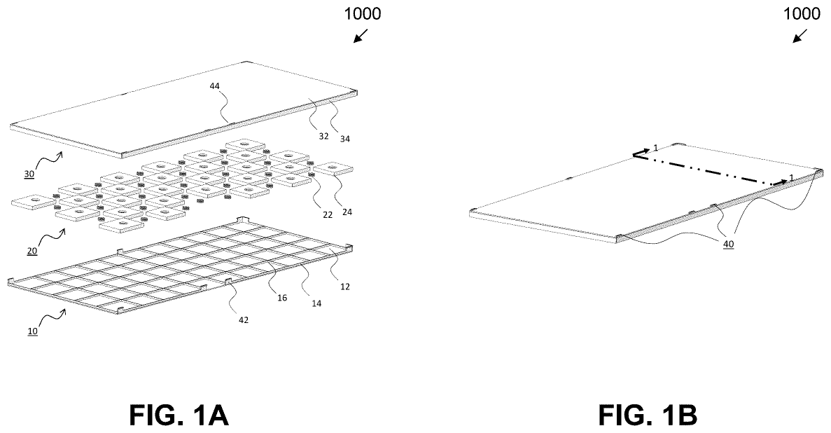

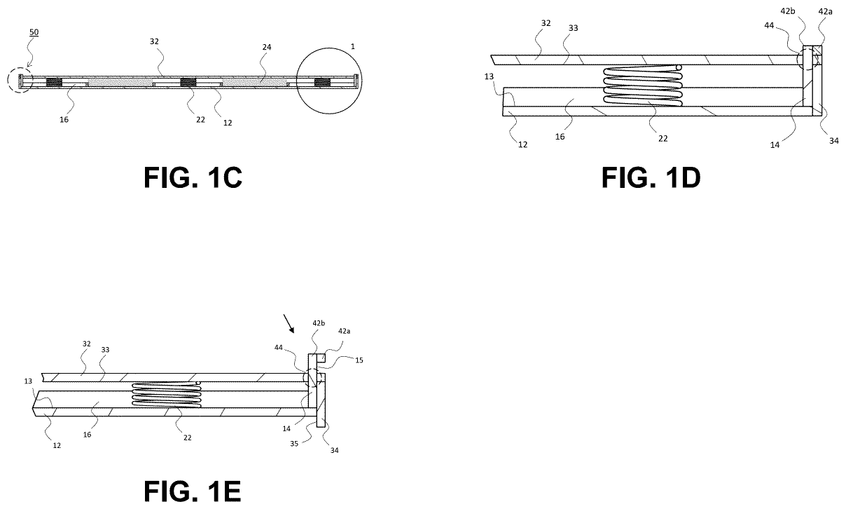

### FIGS. 1A 1B 1C 1D 1E

FIG. 1A (exploded isometric view) and FIG. 1B (isometric view) and FIG. 1C (cross-sectional view) and FIG. 1D (enlarged cross-sectional view) show an example embodiment of an impact-robust closure comprising a door 1000. It comprises an impact receiver 10, an impact reducer 20, a backing 30, a plurality of couplers 40, and a joint 50.

The impact receiver 10 comprises a plate 12 made from steel and peripheral stiffeners 14 and horizontal and vertical intermediate stiffeners 16 made from steel welded to the surface 13 of the plate 12 at predetermined distances. The impact reducer 20 comprises elastically deformable steel springs 22 and elastically deformable foams 24 disposed against the surface 13 of the plate 12 at predetermined locations between the peripheral stiffeners 14 and intermediate stiffeners 16. The backing 30 comprises a plate 32 made from steel and peripheral stiffeners 34 made from steel welded to the surface 33 of the plate 32. The length between the peripheral stiffeners 34 of the backing 30 is slightly larger than the exterior length of the impact receiver 10. Couplers 40, as seen in FIG. 1D and FIG. 1E, comprise L-shaped latches 42 attached to the surface 13 of the plate 12, and their corresponding holes 44 on the plate 32 of the backing 30.

The impact receiver 10 and the impact reducer 20 are inserted in the backing 30 to make the impact reducer 20 touch the surface 33 of the plate 32 and so that the coupler latches 42 projecting outward from the surface 13 are aligned with and extend outward from their corresponding holes 44. The end pieces 42a of the latches 42 are welded to the base pieces 42b after the insertion. Joint 50, as seen in FIG. 1C and FIG. 1E, comprises the surfaces 15 of the impact receiver 10 and the surfaces 35 of the backing 30. The surfaces 15 and/or 35 have a low-friction material coating.

The operation of the first embodiment is illustrated in FIG. 1E (enlarged cross-sectional view). The impact receiver 10 receives the impact forces from its source and starts moving towards the plate 32 of the backing 30. Joint 50 guides the impact receiver 10 towards the impact reducer 20. The low-friction material coating on the surface 15 and/or surface 35 reduces the friction and prevents sticking of the joint 50. Peripheral stiffeners 34 of the backing 30 reduce tilting of the impact receiver 10 inside the backing 30. This makes the elastic deformation of the impact reducer 20 more uniform when the impact forces are applied to a location other than the center of the impact receiver 10. Couplers 40 keep the impact receiver 10, the impact reducer 20, and the backing 30 contiguous before, during, and after the impact forces are applied. Elastic deformation of the impact reducer 20 elongates the duration of the impact forces and reduces the impact forces. Elastic deformation of the impact receiver 10 and the backing 30 further elongates the collision duration, thereby reducing the impact forces. The damping effect of the elastic foam materials 24 diminishes the vibration that can occur after application of an impact force, thereby reducing damage from resonating loads.

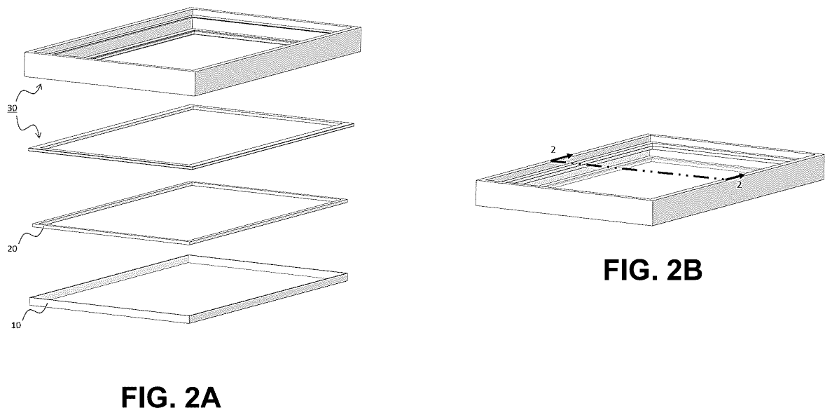

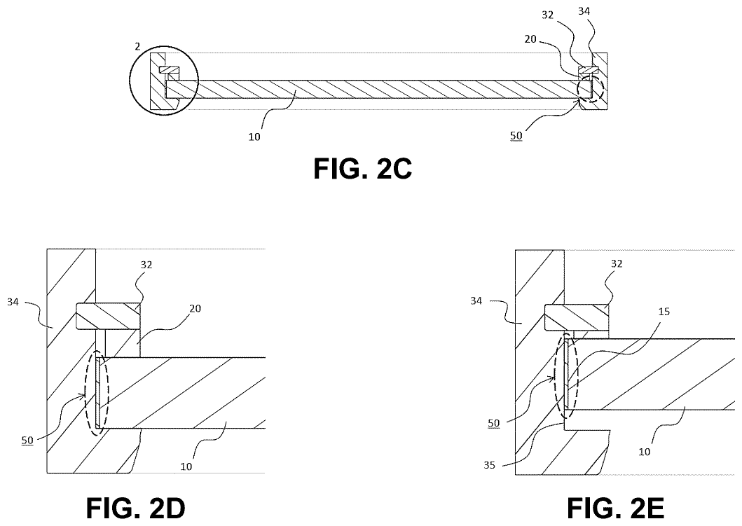

### FIGS. 2A 2B 2C 2D 2E

The second embodiment is illustrated in FIG. 2A (exploded isometric view), FIG. 2B (isometric view), FIG. 2C (cross-sectional view), and FIG. 2D (enlarged cross-sectional view). It comprises an impact receiver 10, an impact reducer 20, a backing 30, and a joint 50. The impact receiver 10 is an impact and blast-resistant glass sheet and the impact reducer 20 is an elastically deformable frame-shaped foam. The backing 30 comprises four plates 32 made of aluminum and peripheral stiffeners 34 made of aluminum. In one example manufacturing approach, the impact receiver 10 may be placed in the peripheral stiffeners 34, after which the impact reducer 20 may be glued to the impact receiver 10. The plates 32 can then be embedded in peripheral stiffeners 34. Joint 50 comprises the surfaces 15 of the impact receiver 10 and the surfaces 35 of the backing 30. The surfaces 15 and/or 35 have a low-friction material coating.

FIG. 2E is an enlarged view of the encircled portion 2 of the example impact-robust closure illustrated in FIG. 2C in a position responsive to application of an impact force. The impact receiver 10 receives the impact forces from its source and starts moving towards the backing 30. Joint 50 guides the impact receiver 10 towards the impact reducer 20. The low-friction material coating on the surfaces 15 and/or 35 reduces the friction and prevents sticking of the joint 50. Peripheral stiffeners 34 of the backing 30 reduce tilting of the impact receiver 10 inside the backing 30. This makes the elastic deformation of the impact reducer 20 more uniform when the impact forces are not applied to the center of the impact receiver 10. Elastic deformation of the impact reducer 20 elongates the duration of the impact force, and reduces the impact forces. Elastic deformation of the backing 30 further elongates the duration of the impact force, and reduces the impact forces. Elastic deformation of the impact reducer 20 is larger than the elastic deformation of the backing 30. The damping effect of the foam 24 diminishes the vibration after the application of the impact force, and reduces damage from resonating loads.

In accordance with the disclosure, a method is provided for absorbing impact forces applied to a closure installed in an opening of a structure. The method comprises installing a closure comprising an anchoring panel secured to a frame of the structure and at least one floating panel elastically coupled to the anchoring panel by an elastic coupler. Upon application of an impact force to the floating panel, the method further comprises permitting the floating panel to translate relative to the anchoring panel along a single translational axis, thereby elastically deforming the elastic coupler. The elastic deformation of the elastic coupler absorbs at least a portion of the impact force and elongates a duration of the impact event, thereby reducing the impact force transmitted to the anchoring panel, the frame, and associated anchoring hardware. Following the impact, the method further comprises applying a restoring force generated by the elastic coupler to return the floating panel back to an unloaded position. In some implementations, the method further comprises limiting translation of the floating panel in at least one direction using interlocking stoppers disposed on the anchoring panel and the floating panel, while permitting translation in an opposite direction. The method may be applied to closures comprising one or more floating panels, one or more elastic couplers, and elastic couplers configured for compression, extension, or bidirectional elastic deformation.

From the description above, a number of advantages of some embodiments become evident: a) The impact forces are reduced on all parts of the doors and windows and barriers and their supports including the hinges and locking mechanisms; b) The doors and windows and barriers and their supports can withstand impact forces from heavier objects and more powerful blasts; c) The doors and windows and barriers and their supports can withstand impact forces with no need for modifying existing parts; d) The doors and windows and barriers and their supports can withstand impact forces with no need for increasing the size of existing parts; e) The doors and windows and barriers and their supports can withstand impact forces with no need for stronger materials; f) The doors and windows and barriers maintain their capacity to reduce impact forces after application of an impact force; g) Safety and ease of operation are increased depending on the type of the doors and windows; h) The cost of construction, transportation, and installation of the doors and windows and barriers and their supports is reduced; i) The damage and injuries to humans and objects from impacting the doors and windows and barriers are reduced; j) The damage from the impact forces in the doors and windows and barriers and their supports are reduced; and k) Weight of the doors and windows and barriers and their supports is reduced.

There are also various possibilities with regard to how the doors and windows and barriers are connected to their supports. It includes different types of frames, hinges, locks, rails, bearings, pivots, tracks, and latches.

There are various implementation possibilities for connecting the impact reducer 20 to the impact receiver 10 and backing 30. In one example implementation, the impact reducer 20 is attached to the impact receiver 10. In another example implementation, the impact reducer 20 is attached to the backing 30. In another example implementation, the impact reducer 20 is attached to both the impact receiver 10 and the backing 30. In another example implementation, the impact reducer 20 is detached from both the impact receiver 10 and the backing 30.

There are also various suitable methods to attach the parts of the impact receiver 10, impact reducer 20, backing 30, coupler 40, and joint 50. These include fastening, inserting, using adhesives, welding, soldering, brazing, press-fitting, using latches, and other attachment methods.

There are also various possibilities with regard to the number of impact receivers 10. In one configuration, the doors and windows and barriers have one impact receiver 10. In another configuration, the doors and windows and barriers have a plurality of impact receivers 10. There are also various possibilities with regard to the number of impact reducers 20. In one configuration, the doors and windows and barriers have one impact reducer 20. In another configuration, the doors and windows and barriers have a plurality of impact reducers 20. There are also various possibilities with regard to the number of backings 30. In one configuration, the doors and windows and barriers have one backing 30. In another configuration, the doors and windows and barriers have a plurality of backings 30. There are also various possibilities with regard to the number of couplers 40. In one configuration, the doors and windows and barriers have one coupler 40. In another configuration, the doors and windows and barriers have a plurality of couplers 40. There are also various possibilities with regard to the number of joints 50. In one configuration, the doors and windows and barriers have one joint 50. In another configuration, the doors and windows and barriers have a plurality of joints 50. There are also various possibilities with regard to the number of supports. In one configuration, the doors and windows and barriers have one support. In another configuration, the doors and windows and barriers have a plurality of supports.

There are also various materials suitable for construction of the impact receiver 10, backing 30, coupler 40, and joint 50, including carbon fiber, glass, metal, polymers, wood, and other engineering materials. The impact reducer 20 can be made of materials and devices that can elastically deform including elastic foam and springs. The impact reducer 20 is configured to deform elastically when loaded, and to substantially recover its shape after the load is removed. The joint 50 can have a coating of materials with low-friction properties. Joint 50 can include ball bearings and other low-friction mechanisms.

There are also various possibilities with regard to the mode of operation. In one configuration, the impact reducer 20 works in compression. In another configuration, the impact reducer 20 works in tension. In another configuration, the impact reducer 20 works in both tension and compression. In one configuration, the impact receiver 10 is sliding in the impact reducer 20. In another configuration, the impact receiver 10 is sliding over the impact reducer 20.

There are also various possibilities with regard to the parts used in the doors and windows and barriers. In one configuration, the doors and windows and barriers comprise at least one impact receiver 10 and at least one impact reducer 20. In another configuration, the doors and windows and barriers comprise at least one impact receiver 10 and at least one impact reducer 20 and couplers 40. In another configuration, the doors and windows and barriers comprise at least one impact receiver 10 and at least one impact reducer 20 and at least one joint 50. In another configuration, the doors and windows and barriers comprise at least one impact receiver 10 and at least one impact reducer 20 and couplers 40 and at least one joint 50. In another configuration, the doors and windows and barriers comprise at least one impact receiver 10 and at least one impact reducer 20 and at least one backing 30. In another configuration, the doors and windows and barriers comprise at least one impact receiver 10 and at least one impact reducer 20 and at least one backing 30 and couplers 40. In another configuration, the doors and windows and barriers comprise at least one impact receiver 10 and at least one impact reducer 20 and at least one backing 30 and at least one joint 50. In another configuration, the doors and windows and barriers comprise at least one impact receiver 10 and at least one impact reducer 20 and at least one backing 30 and couplers 40 and at least one joint 50.

There are also various possibilities with regard to the order of the impact receiver 10, the impact reducer 20, and the backing 30. In one configuration, the impact reducer 20 is sandwiched between the impact receiver 10 and the backing 30. In another configuration the backing 30 is sandwiched between the impact receiver 10 and the impact reducer 20. In another configuration the backing 30 is sandwiched between one impact reducer 20 and one impact receiver 10 on one side and another impact reducer 20 and impact receiver 10 on the other side.

There are also various possibilities with regard to position of the couplers 40. In one configuration, the coupler latches 42 are attached to the impact receiver 10 and the corresponding holes 44 are located on the backing 30. In another configuration, the coupler latches 42 are attached to the backing 30 and the corresponding holes 44 are located on the impact receiver 10. In another configuration, there are neither coupler latches 42 nor corresponding holes 44 on either of the impact receiver 10 or backing 30. There are also various possibilities with regard to placement patterns of impact reducer 20 parts, including spring 22 and foam 24.

There are various possibilities with regard to shapes and sizes of the impact receiver 10, impact reducer 20, backing 30, coupler 40, joint 50, and their parts.

The described method and apparatus reduce impact forces on all parts of the doors and windows and barriers and their supports, thus the reader will see that this method has the additional advantages in that: It enables the doors and windows and barriers and their supports to withstand impact forces from heavier objects and more powerful blasts. It enables the doors and windows and barriers and their supports to withstand impact forces without the need for modifying existing parts. It enables the doors and windows and barriers and their supports to withstand impact forces without the need for increasing parts' size. It enables the doors and windows and barriers and their supports to withstand impact forces without the need for stronger materials. It enables the doors and windows and barriers to maintain their capacity to reduce impact forces after the application of the impact force. It increases the safety and ease of operation depending on the type of the doors and windows. It reduces the cost of construction, transportation, and installation of the doors and windows and barriers and their supports. It reduces the damage and injuries from the doors and windows and barriers impacting humans, animals, and objects. It reduces the damage from impact forces on the doors and windows and barriers and their supports. It reduces the weight of the doors and windows and barriers and their supports.

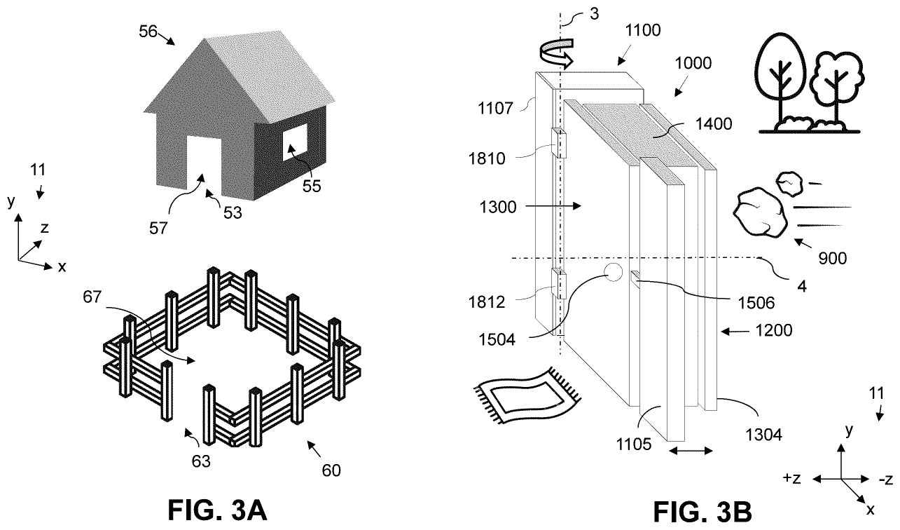

### FIGS. 3A 3B

FIG. 3A is a pictorial diagram illustrating example applications for closures according to the disclosure. FIG. 3A shows a building 56 encloses a space 57. Building 56 includes an opening 53 for entering and exiting enclosed space 57. Building 56 also has an opening 55 for providing a view and/or permitting airflow between enclosed space 57 and the outdoor environment of building 56. A space 67 of a yard is enclosed by a fence 60. Fence 60 includes an opening 63 for allowing entry and exit from enclosed space 67. Each of these openings is typically closed by a structure such as a door to close opening 53, a window to close opening 55 and a gate to close opening 63. However, it is important to note the closures disclosed herein are not limited to the particular type of applications, structures or spaces depicted in FIG. 3A. The closures disclosed herein will find application in closing openings in a wide variety of structures including fences, houses, sheds, shelters, turnstiles, vehicles, and so on.

FIG. 3D is a pictorial diagram illustrating an example closure comprising a door 1000 according to the disclosure. Door 1000 comprises an anchoring panel 1300, a floating panel 1200 and an elastic coupler 1400 disposed between anchoring panel 1300 and floating panel 1200 to elastically couple floating panel 1200 to anchoring panel 1300. Dimensions depicted in FIG. 3D are not to scale. Relative dimensions such as dimensions of elastic coupler 1400, floating panel 1200 and anchoring panel 1300 are exaggerated to highlight salient features.

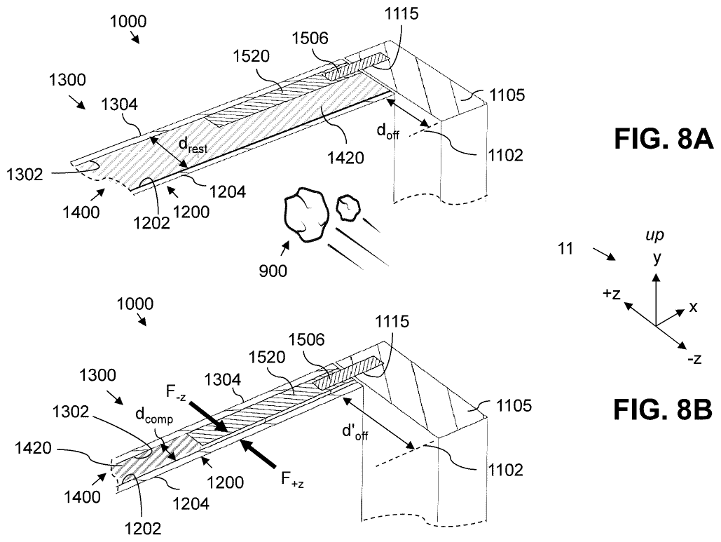

A frame 1100 (shown in FIG. 3B) includes latch jamb 1105 and hinge jamb 1107. Frame 1100 would typically be anchored to a building structure such as building 56 (FIG. 3A). FIG. 3B shows door 1000 disposed within frame 1100 with anchoring panel 1300 rotatably anchored to hinge jamb 1107 of frame 1100 via hinges 1810 and 1812, thereby providing anchoring panel 1300 with one rotational degree of freedom relative to the building about a hinge axis 3. In some implementations, anchoring panel 1300 is configured to be attached to a latch 1506. Latch jamb 1105 of frame 1100 is configured to have a latch-receiving opening 1115 (illustrated in FIG. 8A).

Floating panel 1200 is coupled to anchoring panel 1300 via elastic coupler 1400, so as to provide floating panel 1200 with one translational degree of freedom relative to the anchoring panel along axis 4 which extends through and perpendicular to a plane defined by floating panel 1200. When latch 1506 is engaged in latch engaging portion of latch jamb 1105, anchoring panel 1300 is anchored with zero degrees of translational and rotational freedom relative to the frame 1100, and axis 4 will be perpendicular to a vertical plane defined by latch jamb 1105 and hinge jamb 1107 of frame 1100.

Either or both of anchoring panel 1300 and/or floating panel 1200 can be constructed from materials having a high strength rating and/or a high stiffness. Panels with higher stiffness materials deform less under load, compared to materials with lower stiffness. Panels constructed of higher stiffness materials tend to maintain their shape and are less prone to deforming over time.

While high stiffness materials have many advantages, they also have some drawbacks, especially when it comes to high-impact collisions. All other factors being equal (e.g. same door size; same projectile mass and velocity) the shorter the duration of a collision, the higher the magnitude of the impact force generated during the collision. This impulse-momentum relationship can be expressed as:

$$F = \frac{m Δ v}{Δ t} \qquad ( Eq . 1 )$$

where force (F) is in newtons (N), change in momentum (m Δv) is in kilogram meters per second (kg m/s), and the time duration of the collision (Δt) is in seconds (s).

From Eq. 1 it can be seen that increasing the time duration of the collision decreases the magnitude of force exerted by a moving object 900 on floating panel 1200. Collision time duration is inversely proportional to closure stiffness in the direction of the collision. Thus, the duration of a collision between moving object 900 and a panel constructed of higher stiffness materials will be shorter than the duration of a collision between moving object 900 and a panel constructed of lower stiffness materials, all other relevant factors being equal. Consequently, when impacted by a heavier and/or faster moving object, the higher stiffness material will generate a higher impact force than would be generated by the lower stiffness. If the impact force generated in a collision exceeds a panel material's strength, the panel will fail regardless of its stiffness.

Door 1000 is an example of a closure having an impact-receiving panel (floating panel 1200) that can have better impact resistance without shortening collision duration while having higher stiffness materials. In contrast, for conventional impact-receiving panels the higher the stiffness of the materials, the shorter the collision duration.

For example, anchoring panel 1300 and/or floating panel 1200 can be constructed with high stiffness material like steel. In one implementation floating panel 1200 can be constructed from steel sheet metal. In a conventional panel, this material will respond to dynamic loading conditions in a manner that shortens the time duration of a collision due to its higher stiffness, as compared to the response of a material with a lower stiffness. Shortened collision time generates a higher impact force on the panel during the collision. If the impact force generated during a collision exceeds the strength of the panel material and/or anchoring hardware, the panel and/or anchoring hardware will fail regardless of the panel material stiffness.

Conventional high-impact rated closures made of high stiffness materials produce greater impact forces. This creates yet another disadvantage in that closures made of high stiffness materials apply greater impact forces on their supports and the anchoring hardware. This can cause failure of anchoring hardware and supports and therefore the failure of the closure.

Advantageously, floating panel 1200 as disclosed herein can be constructed of higher stiffness materials without generating correspondingly higher impact forces during a collision. Unlike conventional panels, the duration of a collision between floating panel 1200 and moving object 900 will depend both on the lower stiffness material of which elastic coupler 1400 is constructed, and the higher stiffness materials of which floating panel 1200 is constructed.

Elastic coupler 1400 is disposed between anchoring panel 1300 and floating panel 1200 to couple floating panel 1200 to anchoring panel 1300 such that floating panel 1200 permits translational movement along the +z axis of reference indicia 11, i.e. direction of the impact. As described above, floating panel 1200 is free of anchors to frame 1100.

Floating panel 1200 is the ‘impact-receiving’, or ‘projectile contacting’ structure of door 1000. Conventional projectile-contacting door structures are anchored. That is, they are connected to a frame via anchoring hardware like hinges and latches. In a collision with moving object 900 in which perpendicular forces are applied to the conventional impact-receiving door structure, the collision duration is determined to a great extent by the stiffness of the door's materials.

In contrast, the impact-receiving structure of door 1000 is floating panel 1200, which has freedom of translational motion toward anchoring panel 1300, along the +z axis of reference indicia 11, i.e. direction of the impact. In a collision between moving object 900 and door 1000, collision duration is determined by the stiffness of floating panel 1200 and elastic coupler 1400. These parameters determine the extent to which floating panel 1200 translates along the +z axis, i.e. direction of the impact, toward anchoring panel 1300 during the collision.

For example, a conventional high-impact fiberglass impact-receiving panel can have a high strength rating as well as a high stiffness that strongly opposes deformation under high-impact loads. That strong opposition to deformation also acts to shorten collision duration, thereby generating higher impact forces during a collision than would be generated by material with a lower stiffness rating. The higher impact forces increase the risk of sudden, catastrophic failure of the panel during an impact event, which is what industry standards aim to prevent. Also, the higher stiffness materials increase the impact forces that conventional impact receiver structures transfer to the door's supporting frames and anchors, which must also withstand high impacts to achieve a high-impact rating.

In other words, elastic coupler 1400 decreases the effective stiffness of the closure and provides a greater displacement capacity for the floating panel 1200 in a collision. In a collision with moving object 900 that applies a perpendicular force, floating panel 1200 will displace elastic coupler 1400 by compression, before the materials of floating panel 1200 would deform beyond their elastic limit in response to the perpendicular force. The deformation of elastic coupler 1400 extends the duration of the collision and therefore reduces the impact force generated by deceleration of moving object 900 after it strikes floating panel 1200. This allows floating panel 1200 to be constructed of a higher stiffness material, without incurring the undesirable side effect of generating a correspondingly higher impact forces during a collision.

Because elastic coupler 1400 is constructed of an elastic material, and because floating panel 1200 is configured to permit translational movement toward and away from anchoring panel 1300, door 1000 can absorb a higher impact and still return to its pre-impact state intact, as compared to conventional doors, even those whose cores may be filled with an impact-absorbing material. In the conventional door, the entire door is anchored to a frame. Referring to door 1000, anchoring panel 1300 is anchored to frame 1100 by hinges and latches and floating panel 1200 is coupled to anchoring panel 1300 by elastic coupler 1400.

In a conventional door one side of the door may be the impact-receiving side and the other side may have anchors to a frame. The door may have material disposed between the impact-receiving side and the opposing side to dampen oscillations that may occur as a result of an impact. However, the impact-receiving side is nonetheless rigidly attached to the opposing side. The two sides have zero degrees of translational and rotational freedom relative to each other. A perpendicular force applied to the impact-receiving side would not cause the impact-receiving side to translate toward the opposing side. Rather, it would cause deformation only. If the impact-receiving side is constructed of a high stiffness material to meet a high-impact rating, the force could cause the receiving side and/or the anchoring hardware to break, buckle, or fail otherwise. Instead of the impact-receiving side translating to increase the impact time and reduce the impact force during a collision, the momentum would be rapidly transmitted through the more rigid structures directly to the points of connection: the hinges and the latching mechanism. Thus, conventional high-impact doors may require reinforced hinges, latches, and screws to withstand such high-impact forces without failing.

In contrast, floating panel 1200 is the force receiving structure of door 1000. Impact forces are transferred from floating panel 1200 to anchoring panel 1300, hinges, latches, screws, and to frame 1100 through elastic coupler 1400. Elastic coupler 1400 reduces impact force by extending collision duration, thereby eliminating some of the force that would otherwise be applied to anchoring panel 1300 in a collision.

In some implementations, elastic coupler 1400 comprises a viscoelastic polymer material selected to have a high damping capacity, thereby further reducing the magnitude of force transferred to anchoring panel 1300. In some implementations elastic coupler 1400 comprises an ethylene-vinyl acetate that can undergo significant deformation without exceeding its elastic limit or experiencing permanent deformation. Thus, elastic coupler 1400 can spring back (along with floating panel 1200) and maintain its form, and the form of door 1000 for repeated impacts. As a result, door 1000 including its anchoring panel 1300 may be able to pass a high-impact rating test without necessitating reinforced anchoring hardware.

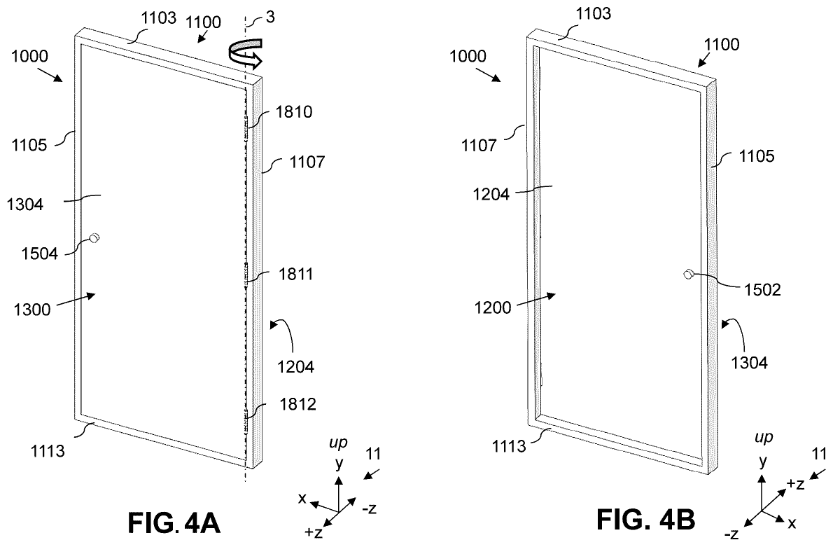

### FIGS. 4A 4B

FIGS. 4A and 4B are isometric views of an example implementation of an example resilient, force-absorbing door 1000 (shown in FIG. 3B) according to the disclosure. FIG. 4A shows door 1000 disposed in a frame 1100 in a view from the interior of an enclosed space. Frame 1100 comprises a head jamb 1103, a sill 1113, a hinge jamb 1107 and a latch jamb 1105. In use, frame 1100 is fixedly attached to a building structure such as building 56 (FIG. 3A).

FIG. 4A only shows anchoring panel 1300. Anchoring panel 1300 includes an exterior surface 1304 and an interior surface 1302. In the example of FIG. 4A anchoring panel 1300 is equipped with hinges 1810 1811 1812 on its hinge jamb side such that anchoring panel 1300 (and door 1000) is rotatable about hinge axis 3.

FIG. 4B is an isometric view of the example door 1000 of FIG. 4A including floating panel 1200 disposed in frame 1100 in an arrangement with elastic coupler 1400 (not shown) and anchoring panel 1300 (shown in FIG. 4A) in view from the exterior of an enclosed space. In a collision with a moving object, similar to moving object 900 in FIG. 3D, floating panel 1200 is the impact-receiving panel. Floating panel 1200 comprises an exterior surface 1204 and an interior surface 1202.

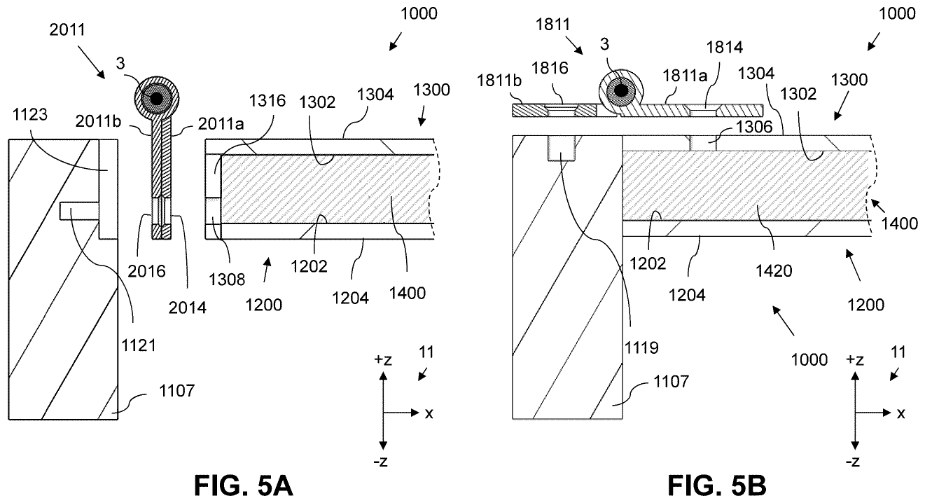

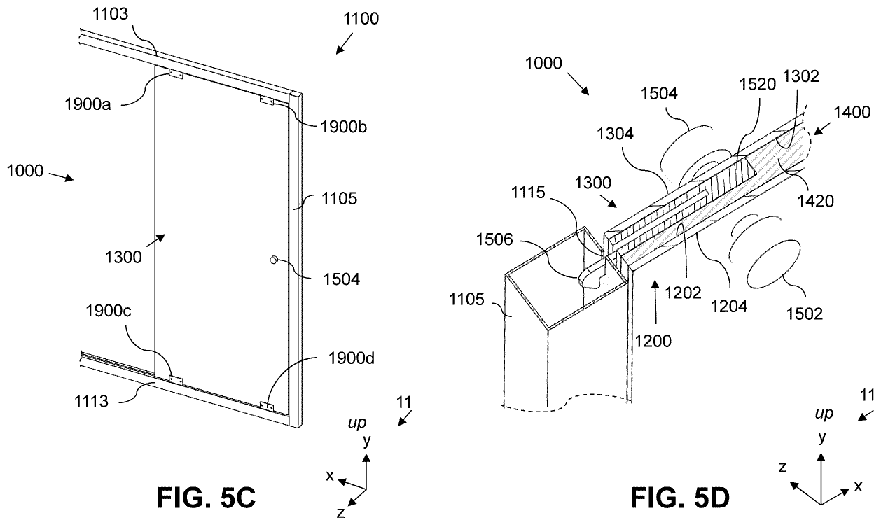

### FIGS. 5A 5B 5C 5D

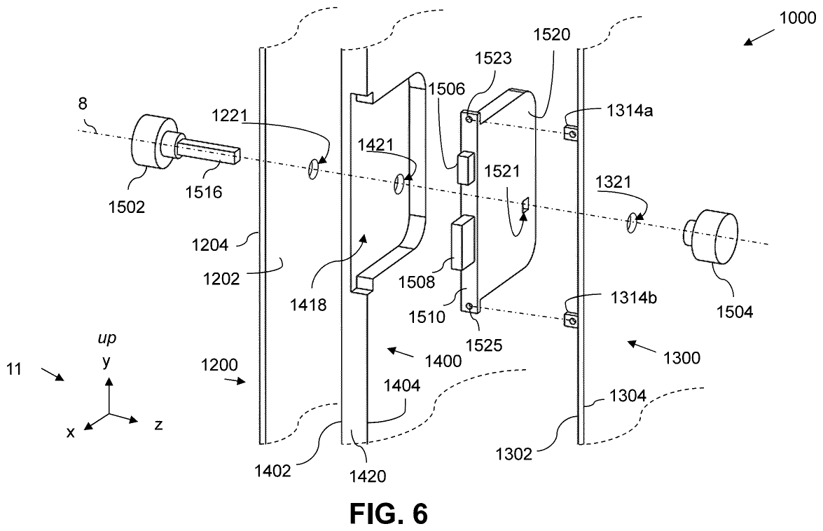

FIG. 5A is a cross-sectional top view of a portion of a hinge jamb side of the example door 1000 illustrated in FIGS. 4A 4B. Anchoring panel 1300 (shown in FIG. 5A) can have hinge tab 1316 configured with a threaded opening 1308 for engaging threads of a bolt, screw, or other affixing methods (not shown) to affix first hinge portion 2011a to anchoring panel 1300 via opening 2014 of first hinge portion 2011a. Hinge jamb 1107 of frame 1100 is configured to engage second hinge portion 2011b of hinge 2011 via opening 2016 of second hinge portion 2011b corresponding to bolt-receiving opening 1121 in hinge mortise 1123 of hinge jamb 1107, thereby anchoring panel 1300 to frame 1100 so as to permit rotation of anchoring panel 1300 about a hinge rotation axis 3, along the y axis of reference indicia 11, when latch 1506 (example illustrated in FIG. 6) is disengaged, while preventing any translational displacement of anchoring panel 1300. Significantly, anchoring panel 1300 is configured for disposition of hinges, e.g. hinge 2011, and latch 1506 such that neither hinge 2011 nor latch 1506 presents any opposition to translational movement of floating panel 1200 even when latch 1506 is engaged in latch-receiving opening 1115 of frame 1100.

As noted above, with hinge 2011 installed on its hinge side, and with latch 1506 on its latch side disengaged from latch-receiving opening 1115, anchoring panel 1300 (and door 1000) can rotate about hinge axis 3. In contrast, with hinge 2011 installed on its hinge side, and with latch 1506 on its latch side engaged in latch-receiving opening 1115, anchoring panel 1300 is anchored to frame 1100.

FIG. 5B is a cross-sectional top view of a portion of a hinge jamb side of an alternative implementation of the example door 1000 illustrated in FIGS. 4A 4B. Anchoring panel 1300 is configured with a threaded opening 1306 for engaging threads of a bolt, screw, or other affixing methods (not shown) to affix first hinge portion 1811a to anchoring panel 1300 via opening 1814 of first hinge portion 1811a. Hinge jamb 1107 of frame 1100 is configured to engage second hinge portion 1811b of hinge 1811 via opening 1816 of second hinge portion 1811b corresponding to bolt-receiving opening 1119 in hinge jamb 1107, thereby anchoring panel 1300 to frame 1100 so as to permit rotation of anchoring panel 1300 about a hinge rotation axis 3, along the y axis of reference indicia 11, when latch 1506 is disengaged, while preventing any translational displacement of anchoring panel 1300. Significantly, anchoring panel 1300 is configured for disposition hinges, e.g. hinge 1811, and latch 1506 (FIG. 8A) such that neither hinge 1811 nor latch 1506 presents any opposition to translational movement of floating panel 1200 even when latch 1506 is engaged in latch-receiving opening 1115 of frame 1100.

As noted above, with hinge 1811 installed on its hinge side, and with latch 1506 on its latch side disengaged from latch-receiving opening 1115, anchoring panel 1300 (and door 1000) can rotate about hinge axis 3. In contrast, with hinge 1811 installed on its hinge side, and with latch 1506 on its latch side engaged in latch-receiving opening 1115, anchoring panel 1300 is anchored to frame 1100.

FIG. 5C is an isometric view of an alternative implementation of the example door 1000 according to the disclosure. Anchoring panel 1300 is slidably anchored to a head jamb 1103 via track hangers 1900a 1900b, and corresponding rollers and a track (not shown). Anchoring panel 1300 is also slidably anchored to a sill jamb 1113 via track hangers 1900c 1900d, and corresponding rollers and a track (not shown). Anchoring panel 1300 is thereby provided with one translational degree of freedom relative to a frame 1100 along the x axis of reference indicia 11, i.e. parallel to the head jamb 1103 and the sill jamb 1113.

FIG. 5D is an isometric, cross-sectional top view of a portion of a latch jamb side of the example door illustrated in FIG. 8C. A lock body 1520 including a latch 1506 is disposed within elastic coupler panel 1420. Lock body 1520 may be affixed to a portion of interior surface 1302 on latch jamb 1105 side of anchoring panel 1300. Handles 1502 and 1504 are operable to engage and disengage latch 1506 with a corresponding latch-receiving opening 1115 in latch jamb 1105 of frame 1100.

FIGS. 5A 5B 5C 5D show an example elastic coupler 1400 disposed between floating panel 1200 and anchoring panel 1300. In these examples, elastic coupler 1400 can be implemented as a single, elastically deformable, generally frame-shaped elastic coupler panel 1420, which can be generally of the same dimensions as floating panel 1200 and anchoring panel 1300. However, examples described in detail below show that elastic coupler 1400 is not limited with respect to its shape, dimension or material.

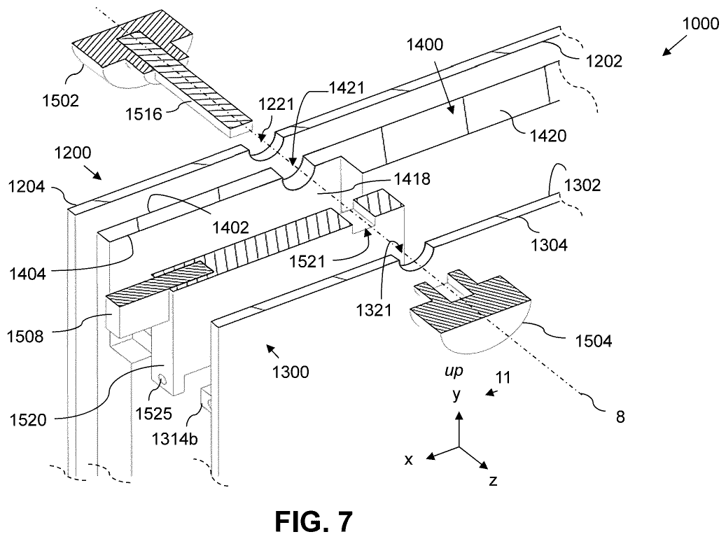

### FIG. 6, FIG. 7

FIG. 6 is an exploded isometric view of a portion of a latch jamb side of an example door 1000. FIG. 7 is an exploded isometric, cross-sectional top view of a portion of a latch jamb side of an example door 1000. Door 1000 comprises floating panel 1200, anchoring panel 1300 and elastic coupler 1400 comprising elastic coupler panel 1420. Floating panel 1200, anchoring panel 1300 and elastic coupler panel 1420 have respective openings 1221 1321 1421 that align along an axis 8 for slidably receiving and passing a spindle 1516 therethrough. Handles 1502 1504 are coupled to opposing ends of spindle 1516.

Lock body 1520 is configured to engage spindle 1516 via opening 1521 such that rotation of either one of handles 1502 1504 in a first direction causes latch 1506 to extend from lock body 1520 into a corresponding latch-receiving opening 1115 formed in latch jamb 1105 of frame 1100 (example illustrated in FIGS. 8A 8B). Rotating either one of handles 1502 1504 in the opposing direction will retract latch 1506 from its extruded position, thereby disengaging latch 1506 from corresponding latch-receiving opening 1115 and permitting door 1000 to rotate about a hinge axis 3. In the example of FIG. 6, lock body 1520 also includes a deadbolt 1508 for engaging a corresponding bolt-receiving opening (not shown) in latch jamb 1105 of frame 1100.

In the examples of FIGS. 6 and 7 elastic coupler panel 1420 is formed to provide a recess 1418 that generally conforms in shape to shapes of commercially available lock bodies, e.g. lock body 1520, such that elastic coupler panel 1420 can receive and support lock body 1520. Recess 1418 can be positioned within elastic coupler panel 1420 so that lock body 1520 can be securely disposed within recess 1418 without compressing the elastic material of elastic coupler panel 1420 when floating panel 1200 is in an unloaded position.

In some implementations, elastic coupler panel 1420 is configured to support lock body 1520 in a position that permits attachment of lock body 1520 to anchoring panel 1300. Significantly, lock body 1520 is not affixed to floating panel 1200. Floating panel 1200 is configured to translate in a substantially perpendicular direction, i.e., toward and away from anchoring panel 1300 with anchoring panel 1300 anchored to frame 1100.

Elastic coupler panel 1420 is adhered to floating panel 1200 or to anchoring panel 1300, or to both. For example, all or a portion of a first surface of side 1402 of elastic coupler panel 1420 can be adhered to a corresponding interior surface 1202 of floating panel 1200. All or a portion of a surface on side 1404 of elastic coupler panel 1420 can be adhered to a corresponding portion of interior surface 1302 of anchoring panel 1300.

Anchoring panel 1300 can include lock tabs 1314a, 1314b configured to align with corresponding openings 1523 1525 respectively of faceplate 1510 of lock body 1520 to facilitate attachment of lock body 1520 to anchoring panel 1300.

### FIGS. 8A 8B

FIGS. 8A and 8B are isometric, cross-sectional top views of a portion of latch jamb side of door 1000. Door 1000 comprises anchoring panel 1300, floating panel 1200 and elastic coupler 1400 comprising elastic coupler panel 1420 disposed therebetween. Lock body 1520 may be attached to a side of anchoring panel 1300. FIGS. 8A 8B depict states of door 1000 before, during, and after a collision between door 1000 and moving object 900.

FIG. 8A depicts an unloaded state of door 1000 at time before the instant t₁ at which an outermost surface of moving object 900 touches exterior surface 1204 of floating panel 1200. This is also the unloaded state that door 1000 will have at some time t₃ (after the instant t₂) at which moving object 900 has broken contact with exterior surface 1204 and floating panel 1200 has returned to its original position. In this unloaded position, floating panel 1200 is separated from anchoring panel 1300 by a distance dᵣₑₛₜ, and is offset from edge 1102 of latch jamb 1105 by d_{off}.

FIG. 8B depicts state of door 1000 at the instant t₂ at which object 900 comes to stop and either bounces back or falls to the ground. At this time (t₂), floating panel 1200 has been displaced from its unloaded position within frame 1100 to a loaded state position closer to anchoring panel 1300. In this loaded state position, floating panel 1200 is separated from anchoring panel 1300 by distance d_{comp}, and is offset from edge 1102 of latch jamb 1105 by d′_{off}.

During the collision time t₁ to t₂, elastic coupler panel 1420 exerts a force (F_{-z}) that opposes displacement of floating panel 1200 toward anchoring panel 1300. Until an instant right before t₂, that opposing force (F_{-z}) is less than the force (F_{+z}) generated by moving object 900. During this time, moving object 900 decelerates from its initial velocity v₁ at the time t₁, to its final velocity v₂ at the time t₂.

When forward velocity (+z), i.e. in the direction of the impact, of object 900 reaches zero (comes to stop), the opposing (restoring) force (F_{-z}) applied by elastic coupler panel 1420 begins to displace floating panel 1200 away from anchoring panel 1300. Ultimately, this restoring force returns floating panel 1200 to its unloaded position (shown in FIG. 8A).

During the collision, anchoring panel 1300 is anchored to frame 1100 so as to substantially restrict translational and rotational movement relative to the frame. Floating panel 1200 exerts a compression force on elastic coupler panel 1420 as it displaces toward anchoring panel 1300 in response to the perpendicular force exerted on floating panel 1200 by moving object 900. Elastic coupler panel 1420 will transfer that compression force to anchoring panel 1300. However, for any given materials of floating panel 1200 and anchoring panel 1300, the compression force transferred from floating panel 1200 to anchoring panel 1300 via elastic coupler panel 1420 will be less than would be transferred in the absence of elastic coupler panel 1420. This is because deformation of elastic coupler panel 1420 extends the duration of the collision as compared to the collision duration without elastic coupler panel 1420, all other relevant factors being equal.

Elastic coupler panel 1420 not only reduces, or partially ‘absorbs’, the force exerted on floating panel 1200 by moving object 900, it also converts a portion of the force bending effect on the anchoring panel 1300 to compression of the elastic coupler panel 1420. This reduction of bending effects reduces bending of the latches that attach anchoring panel 1300 to frame 1100.

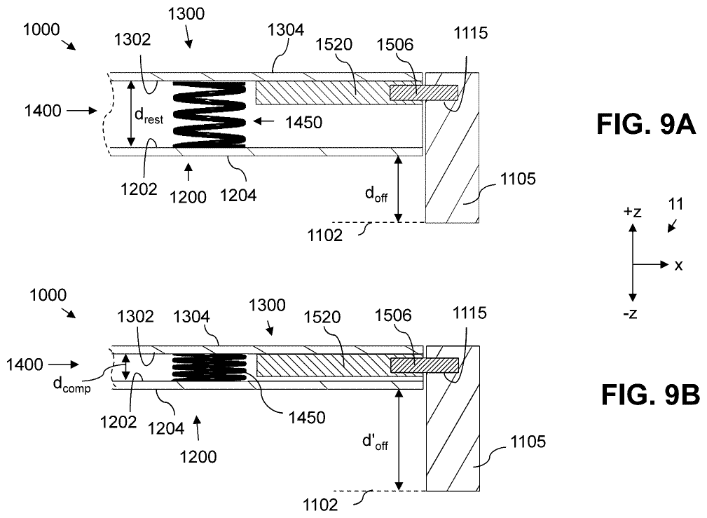

### FIGS. 9A 9B

FIG. 9A is a cross-sectional top view of a portion of a latch jamb side of an example implementation of door 1000 in an unloaded state. FIG. 9B is a cross-sectional top view of a portion of the latch jamb side of the example implementation of door 1000 (shown in FIG. 9A) in a loaded state. Anchoring panel 1300 of door 1000 (shown in FIG. 9A) is anchored, i.e. latch 1506 is engaged in latch-receiving opening 1115 of latch jamb 1105 of frame 1100, and floating panel 1200 is in unloaded position.

In the example implementation of FIG. 9A, elastic coupler 1400 is implemented using one or more coupling springs (one example 1450 shown). Coupling spring 1450 is in unloaded state, i.e. neither extended nor compressed. Anchoring panel 1300 can be configured for attachment of lock body 1520 on a portion of (or close to) its interior surface 1302 (example illustrated in FIG. 6B).

FIGS. 9A 9B (similar to FIGS. SA 8B) depict states of door 1000 before, during, and after a collision between moving object 900 and door 1000. The description above referring to FIGS. SA 8B applies mutatis mutandis to FIGS. 9A 9B.

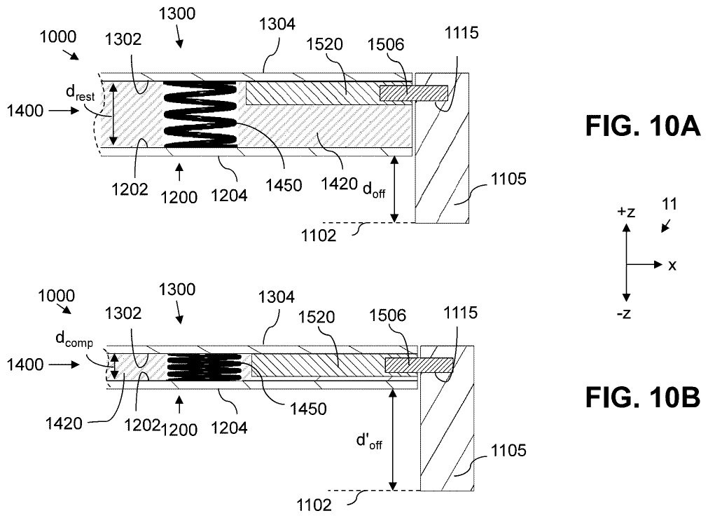

### FIGS. 10A 10B

FIGS. 10A 10B are cross-sectional top views of an example door 1000 including an elastic coupler 1400 implemented as a combination of one or more coupling springs (one example 1450 shown) disposed and at least one elastic coupler panel 1420. Coupling spring 1450 is disposed within elastic coupler panel 1420. FIG. 10A shows coupling spring 1450 and elastic coupler panel 1420 in their unloaded states. FIG. 10B shows coupling spring 1450 and elastic coupler panel 1420 in their loaded states.

FIGS. 10A 10B (similar to FIGS. 8A 8B) depict states of door 1000 before, during, and after a collision between moving object 900 and door 1000. The description above referring to FIGS. SA 8B applies mutatis mutandis to FIGS. 10A 10B.

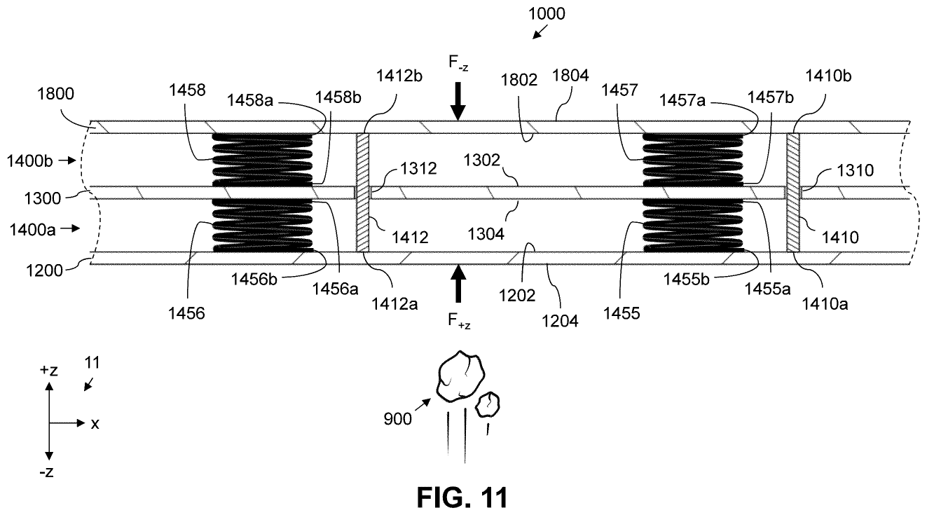

### FIG. 11

FIG. 11 is cross-sectional top view of an intermediate portion of an example implementation of door 1000. In the example of FIG. 11, door 1000 comprises an anchoring panel 1300, a first floating panel 1200, a second floating panel 1800, a first elastic coupler 1400a and a second elastic coupler 1400b. Second floating panel 1800 has an interior surface 1802 and an exterior surface 1804. Anchoring panel 1300 can be rotatably anchored to hinge jamb 1107 of frame 1100 (example illustrated in FIG. 4A, 4B) by one or more hinges attached on a hinge jamb side of anchoring panel 1300. Anchoring panel 1300 can be anchored to the latch jamb 1105 of frame 1100 by a latch 1506 that extends into a latch-receiving opening 1115 on a latch jamb side of anchoring panel 1300 (example illustrated in FIG. 8A, 8B).

In the example of FIG. 11 first elastic coupler 1400a can comprise at least one coupling spring 1455 disposed between anchoring panel 1300 and first floating panel 1200 in a spaced arrangement, along the x axis of reference indicia 11. Likewise, second elastic coupler 1400b can comprise at least one coupling spring 1457 disposed between second floating panel 1800 and anchoring panel 1300. A second coupling spring 1456 is disposed between anchoring panel 1300 and first floating panel 1200. A second coupling spring 1458 is also disposed between second floating panel 1800 and anchoring panel 1300. First coupling springs 1455 1457 are in a spaced arrangement with second coupling springs 1456 1458, along the x axis of reference indicia 11.

In this specification, the ‘natural length’ (L) of a spring is its length when no external forces (Fₑₓₜ) are acting on it. This is the spring's length in its unloaded state. As a spring extends, the distance between its coils increases and the spring lengthens. As a spring compresses, the distance between its coils decreases and the spring shortens.

Stiffness constant is a property of a spring that causes the spring to oppose deformation, i.e. extension or compression. Spring stiffness constant (k) can be expressed in terms of magnitude of external force (Fₑₓₜ) applied to the spring and spring deformation (d) from its natural length (lₙ) using Eq. 2 and Eq. 3. In these equations F is given in Newtons, d is given in meters, and k is given in N/m.

$$k = {F}_{ext} / d \qquad ( Eq . 2 )$$

$${F}_{ext} = k \cdot d \qquad ( Eq . 3 )$$

The internal force (Fᵢₙₜ) (also known as restoring force) exerted by a spring is equal in magnitude and opposite in direction to the external force (Fₑₓₜ), whether the deformation is compression or extension. This relationship is known as Hooke's Law and can be expressed using Eq. 4.

$${F}_{int} = - k \cdot d = - {F}_{ext} \qquad ( Eq . 4 )$$

Eq. 1 to 4 are provided for explanatory purposes and do not limit the elastic behavior of the couplers.

A ‘compression spring’ is a spring that is designed to resist compression forces along its axis linearly, i.e. according to Eq. 4. For example, a compression spring may be formed to have a relatively large distance between its coils when the spring is unloaded. Application of an external compression force could result in shortening the spring without permanently deforming it. However, application of an extension force that would separate the coils even further, could cause the spring to extend beyond its elastic limit. In this case the spring could experience a permanent deformation.

An ‘extension spring’ is a spring that is designed to resist extension forces along its axis linearly, i.e. according to Eq. 4. For example, an extension spring may be formed to have no distance between its coils when the extension spring is unloaded. Application of an external extension force could result in extending the spring without permanently deforming it. However, application of a compression force could not compress the spring any further. In this case the spring could experience a permanent deformation.

In the example of FIG. 11, coupling springs 1455 1456 1457 1458 are neither compression springs nor extension springs. Instead, according to the teachings herein, coupling springs 1455 1456 1457 1458 are made to provide linear reactions (remain elastic) under both compression and extension deformations. FIG. 11 shows coupling springs 1455 1456 1457 1458 in their unloaded states in which they have substantially the same natural length (lₙ) and substantially the same spring stiffness constant (k).

In the example of FIG. 1I coupling spring 1455 can be attached at a spring end 1455b to a first portion of interior surface 1202 of first floating panel 1200. Coupling spring 1455 can be attached at an opposing spring end 1455a to a first portion of exterior surface 1304 of anchoring panel 1300. Coupling spring 1456 can be attached at a spring end 1456b to a second portion of an interior surface 1202 of first floating panel 1200. Coupling spring 1456 can be attached at an opposing spring end 1456a to a second portion of exterior surface 1304 of anchoring panel 1300.

### Likewise,

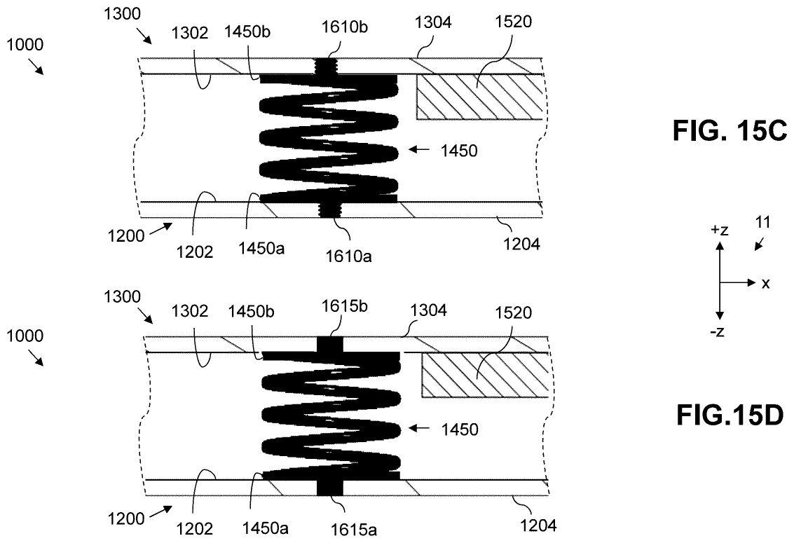

Coupling spring 1457 can be attached at a spring end 1457a to a first portion of interior surface 1802 of second floating panel 1800. Coupling spring 1457 can be attached at an opposing spring end 1457b to a first portion of interior surface 1302 of anchoring panel 1300. Likewise, coupling spring 1458 can be attached at a spring end 1458a to a second portion of interior surface 1802 of second floating panel 1800. Coupling spring 1458 can be attached at an opposing spring end 1458b to a second portion of interior surface 1302 of anchoring panel 1300. FIGS. 15A 15B 15C 15D show examples of attachment methods suitable for attaching coupling springs to panels.

Anchoring panel 1300 (shown in FIG. 11) is formed to include at least two openings 1310 1312 for slidably passing therethrough corresponding panel connectors 1410 1412 respectively. Panel connectors 1410 1412 extend between first floating panel 1200 and second floating panel 1800 in a direction perpendicular to interior surfaces 1202, 1802, along the z axis of reference indicia 11. Panel connectors 1410 1412 are coupled to first floating panel 1200 at respective first panel connector ends 1410a 1412a, and to second floating panel 1800 at respective second panel connector ends 1410b 1412b. In some implementations, first floating panel 1200 and second floating panel 1800 have corresponding panel connector receiving recesses (not shown) configured to engage ends 1412a 1412b of panel connector 1412, and ends 1410a 1410b of panel connector 1410 for lateral (x axis) stabilization of panel connectors 1410 1412 to resist motion of panel connector ends in either direction along the x axis. Forces applied to first floating panel 1200 are transferred to second floating panel 1800 via panel connectors 1410 1412. Forces applied to second floating panel 1800 are transferred to first floating panel 1200 via panel connectors 1410 1412.

As described in detail above, anchoring panel 1300 is configured to be anchored to frame 1100 by hinges on one side and at least a latch on the other (illustrated, e.g. in FIGS. 4A 4B) thereby preventing displacement of anchoring panel 1300 in the +z direction, i.e. direction of the impact, and −z direction, i.e. opposite to the direction of the impact. In contrast, first floating panel 1200 and second floating panel 1800 are configured to have freedom to translate in the +z and −z directions respectively. When a moving object 900 impacts first floating panel 1200, the object applies a force to first floating panel 1200 in the +z direction. If the impact force is sufficient to displace first floating panel 1200 by a distance (d) in the +z direction, first floating panel 1200 will translate toward anchoring panel 1300 by distance (d), whereby first floating panel 1200 will apply a compression force to coupling springs 1455 1456. In response to the application of the compression force, coupling springs 1455 1456 will apply a restoring force to floating panel 1200. The restoring force is applied in the −z direction, thereby opposing the motion of first floating panel 1200 toward anchoring panel 1300. In other words, coupling springs 1455 1456 will act to slow motion of first floating panel 1200 toward anchoring panel 1300.

As first floating panel 1200 translates in the +z direction, i.e. direction of the impact, first floating panel 1200 will apply a force in the +z direction to second floating panel 1800 via panel connectors 1410 1412. In the example of FIG. 11 panel connectors 1410 1412 are rigid. Thus, second floating panel 1800 will undergo displacement in the +z direction by the same distance (d) that first floating panel 1200 is displaced in the +z direction. As noted above, anchoring panel 1300 is anchored to frame 1100. Therefore, displacement of second floating panel 1800 in the +z direction will increase the distance between second floating panel 1800 and anchoring panel 1300, whereby second floating panel 1800 applies an extension force to coupling springs 1457 1458. The internal restoring force of coupling springs 1457 1458 will act on second floating panel 1800 in the −z direction to oppose their extension, thereby opposing motion of second floating panel 1800 in the +z direction and away from anchoring panel 1300. In other words, coupling springs 1457 1458 will act to oppose separation of second floating panel 1800 and anchoring panel 1300 and slow motion of second floating panel 1800 away from anchoring panel 1300.

The restoring force applied by coupling springs 1455 1456 to first floating panel 1200 to oppose its motion toward anchoring panel 1300, and the restoring force applied by coupling springs 1457 1458 to second floating panel 1800 to oppose its motion away from anchoring panel 1300 will combine to slow the motion of first floating panel 1200 (and second floating panel 1800) in the +z direction in response to the impact by moving object 900. The combined effect of floating panel 1200 and floating panel 1800 increases the duration of the impact between moving object 900 and floating panel 1200 more than the effect of first floating panel 1200 alone. As noted above the magnitude of the impact force applied to first floating panel 1200 by moving object 900 is inversely proportional to the impact duration (i.e. length of time between start of impact and cessation of forward motion of moving object 900).

The example door 1000 illustrated in FIG. 11 increases the impact force-dissipating capacity of door 1000 compared to the impact force-dissipating capacity of previous examples that employ a single floating panel. This proportionately decreases the likelihood of damage to door 1000, as well as the likelihood of damage to frame 1100 and any anchoring hardware such as hinges and latches.

In an alternative implementation, coupling springs 1455 1456 disposed between first floating panel 1200 and anchoring panel 1300 can be compression springs, and coupling springs 1457 1458 disposed between second floating panel 1800 and anchoring panel 1300 can be extension springs. When a moving object, e.g. 900, impacts first floating panel 1200, first floating panel 1200 will translate in a direction that would bring first floating panel 1200 closer to anchoring panel 1300, thereby applying a compression force to compression coupling springs 1455 1456 The restoring force of compression coupling springs 1455 1456 will act to oppose the decrease in separation.

At the same time, first floating panel 1200 will apply a force in the +z direction, i.e. direction of the impact, to second floating panel 1800 via panel connectors 1410 1412, thereby increasing the distance of second floating panel 1800 from anchoring panel 1300. This in turn causes second floating panel 1800 to apply an extension force to extension coupling springs 1457 1458. Extension coupling springs 1457 1458 will apply a restoring force in the −z direction to oppose their extension. In other words, in response to an impact on first floating panel 1200 by moving object 900, the restoring force of compression coupling springs 1455 1456 will oppose motion of first floating panel 1200 toward anchoring panel 1300, at the same time, the restoring force of extension coupling springs 1457 1458 are opposing motion of second floating panel 1800 away from anchoring panel 1300. Like the arrangement illustrated in FIG. 11, this alternative implementation increases the force-dissipating capacity of door 1000 and thus decreases the likelihood of damage to door 1000, as well as to its frame 1100 and anchoring hardware.

The alternative implementation can provide the same impact force reduction that is provided by the special coupling springs in the example of FIG. 11, provided the moving object 900 impacts floating panel 1200. However, the alternative implementation has a disadvantage in that if the moving object 900 were to impact floating panel 1800, none of the coupling springs 1455 1456 1457 1458 can function correctly because the compression springs 1455 1456 will need to be extended and extension springs 1457 1458 will need to be compressed. On the other hand, the special coupling springs in the example of FIG. 11 enable door 1000 to have impact reduction capability in both +z and −z directions.

Other alternative implementations are possible depending on the direction of the impact (+z, −z, or both ±z), type of coupling springs (i.e. special, compression, tension), and whether one or both coupling springs 1400a 1400b are used. These alternatives allow proper design of door 1000 based on direction of the impact, available spring types, and required impact reduction capacity. One alternative is similar to the door 1000 of example of FIG. 11 with connectors 1410 and 1412 removed. This allows independent movement of floating panels 1200 and 1800.

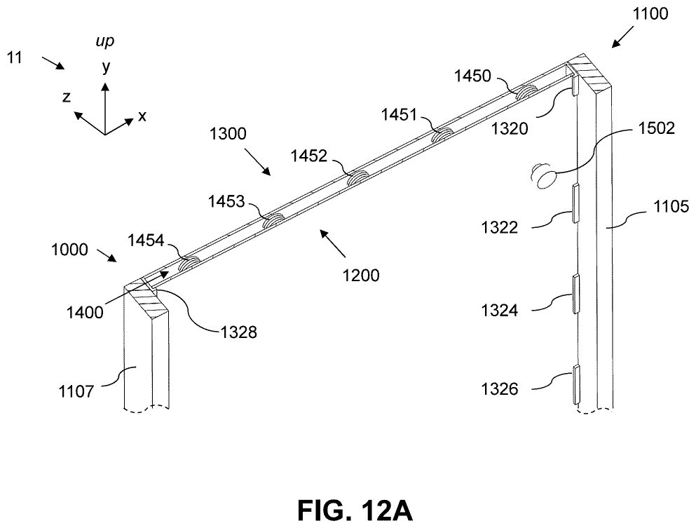

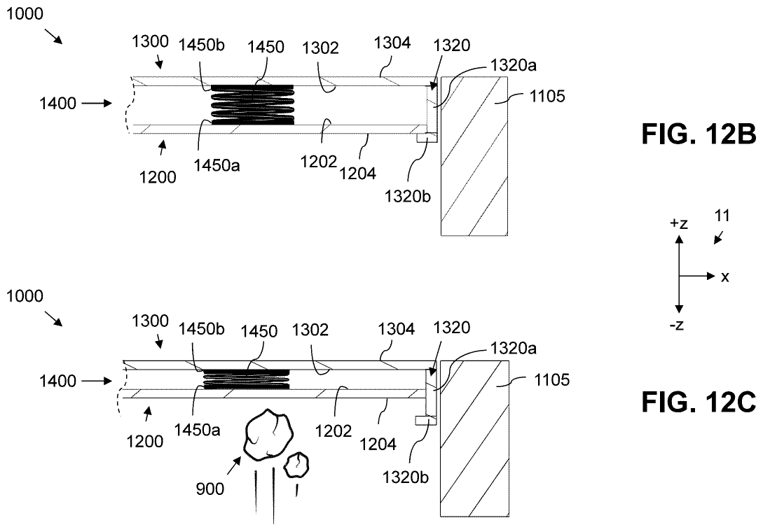

### FIGS. 12A 12B 12C

FIG. 12A is an isometric, cross-sectional top view of an example door 1000 disposed within a frame 1100. FIG. 12B is cross-sectional top view of a portion of the example door 1000 (shown in FIG. 12A) in an unloaded state. FIG. 12C is a cross-sectional top view of the portion of door 1000 (shown in FIG. 12B) in a loaded state. FIG. 12A shows door 1000 comprises anchoring panel 1300, floating panel 1200 and an elastic coupler 1400 comprising a plurality of coupling springs disposed between anchoring panel 1300 and floating panel 1200. FIG. 12A shows coupling springs 1450 1451 1452 1453 1454. The number and arrangement of coupling springs (shown in FIG. 12A) is by way of example only. The disclosure is not limited to the particular number or arrangement of springs illustrated in FIG. 12A. For example, FIG. 1A shows another arrangement of springs (in combination with foams) which would also be suitable for the example of FIG. 12A. A handle 1502 is installed on a latch side of door 1000.

FIG. 12A shows anchoring panel 1300 is made to include a plurality of generally L shaped stoppers, e.g. stoppers 1320 1322 1324 1326, on the latch side of door 1000. Another stopper 1328 is on the hinge side of door 1000 (detailed examples shown in FIG. 4A, FIG. 6B FIG. 6C). Anchoring panel 1300 is anchored on a hinge jamb side to hinge jamb 1107 of frame 1100, and on a latch jamb side to latch jamb 1105 of frame 1100 (anchor examples illustrated, e.g. in FIG. 8A).

FIG. 12B illustrates a generally L shaped stopper 1320 that includes a first portion 1320a extending perpendicularly from interior surface 1302 of anchoring panel 1300. A second portion 1320b of stopper 1320 extends perpendicular to first portion 1320a. FIG. 12B shows coupling spring 1450 and door 1000 are in an unloaded state. In the unloaded position, floating panel 1200 abuts second portion 1320b of stopper 1320. Second portion 1320b serves as a stop that limits movement of floating panel 1200 in the −z direction, i.e., away from anchoring panel 1300.

FIG. 12C shows door 1000 in a loaded state, i.e., at a time of impact of moving object 900 on floating panel 1200. FIG. 12C shows floating panel 1200 is displaced in the +z direction from its unloaded position, i.e., toward anchoring panel 1300, thereby compressing spring 1450. In response to compression, coupling spring 1450 exerts a corresponding restoring force in the −z direction on floating panel 1200, i.e., opposing the motion of floating panel 1200 toward anchoring panel 1300. After overcoming the impact force of object 900, the restoring force of coupling spring 1450 displaces floating panel 1200 away from anchoring panel 1300 until floating panel 1200 is restored to its unloaded position (shown in FIG. 12B). Second portion 1320b of stopper 1320 stops floating panel 1200 from overextending, i.e., extending past its unloaded position under the restoring force.

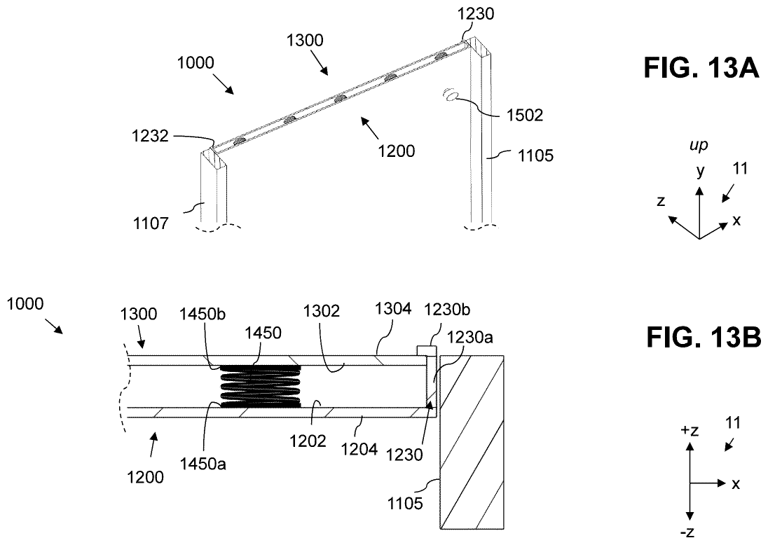

### FIGS. 13A 13B

FIG. 13A is an isometric, cross-sectional top view of an alternative implementation of the example door 1000 (shown in FIGS. 12A 12B 12C) disposed within frame 1100. As with the example of FIGS. 12A 12B 12C, anchoring panel 1300 is anchored (not shown) on a hinge jamb side to hinge jamb 1107 of frame 1100, and on a latch jamb side to latch jamb 1105. Floating panel 1200 is formed to include generally L-shaped stopper 1230 on one end and stopper 1232 on the other end.

FIG. 13B shows stopper 1230 includes a first stopper portion 1230a that extends from a side of floating panel 1200 in the direction of anchoring panel 1300, perpendicular to interior surface 1202 of floating panel 1200. A second stopper portion 1230b extends perpendicular to first stopper portion 1230a so that second stopper portion 1230b abuts anchoring panel 1300 at a surface portion of exterior surface 1304 of anchoring panel 1300.

Door 1000 is configured to permit floating panel 1200 to displace in the +z direction, i.e. direction of the impact, in response to an impact force (as illustrated in FIG. 12C). In the configuration of FIG. 13B, as floating panel 1200 translates toward anchoring panel 1300, coupling spring 1450 will compress and second stopper portion 1230b of L-shaped stopper 1230 will translate in the +z direction away from exterior surface 1304 of anchoring panel 1300. When the impact force in the +z direction is removed from floating panel 1200, the restoring force of coupling spring 1450 will cause floating panel 1200 to translate in the −z direction. At the same time second stopper portion 1230b of L-shaped stopper 1230 will translate toward exterior surface 1304 of anchoring panel 1300 and will come into abutting contact with exterior surface 1304 when coupling spring 1450 is restored to its unloaded length. In that manner second stopper portion 1230b of L-shaped stopper 1230 acts a stop to prevent movement of floating panel 1200 in the −z direction beyond its unloaded position.

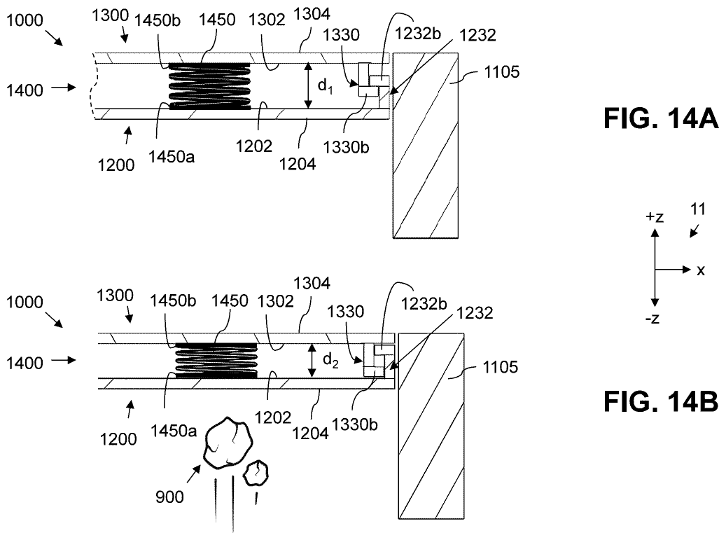

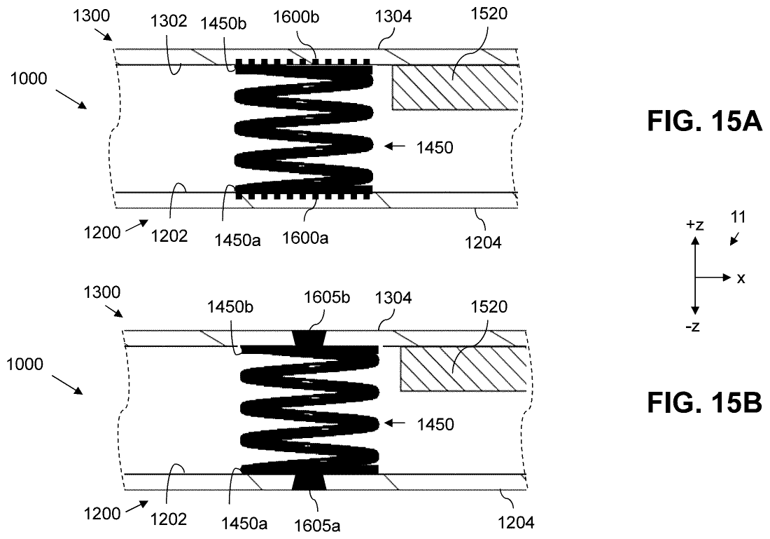

### FIGS. 14A 14B

FIG. 14A is a cross-sectional top view of an alternative implementation of example door 1000 in an unloaded state. FIG. 14A shows door 1000 includes an anchoring panel 1300 which is anchored to frame 1100 (example anchoring configuration shown in FIGS. 4A 8A), and a floating panel 1200 coupled to anchoring panel 1300 via elastic coupler 1400 comprising at least one coupling spring 1450. Floating panel 1200 and anchoring panel 1300 include one or more generally L-shaped stoppers, i.e., stopper 1232 and stopper 1330 respectively.

FIG. 14A shows stoppers 1232 1330 in an interlocked state in an unloaded state of coupling spring 1450. In this state, end piece 1232b of stopper 1232 is in contact with end piece 1330b of stopper 1330. In the interlocked position, end piece 1232b is configured to abut end piece 1330b thereby stopping displacement of floating panel 1200 in the −z direction, while permitting displacement of floating panel 1200 in the +z direction, i.e. direction of the impact.

FIG. 14B is a cross-sectional top view of anchoring panel 1300 of example FIG. 14A in a loaded state due to impact of moving object 900. In this state, end piece 1232b of stopper 1232 can abut interior surface 1302 of anchoring panel 1300, and end piece 1330b of stopper 1330 can abut interior surface 1202 of floating panel 1200, thereby stopping displacement of floating panel 1200 in the +z direction (toward anchoring panel 1300) while permitting displacement of floating panel 1200 in the −z direction under the restoring force applied by coupling spring 1450 to floating panel 1200.

It is important to note FIGS. 14A 14B show example elastic coupler 1400 comprising at least one coupling spring. However, the configuration of anchoring panel 1300 and floating panel 1200 to include interlocking stoppers 1238a 1338a can be implemented using any of the various implementations of elastic coupler 1400 disclosed herein, and their equivalents. Furthermore, overextension of floating panel 1200 can be prevented using alternative methods and devices beyond the described L-shaped latches. For example, the surface 1302 of anchoring panel 1300 can be connected to the surface 1202 of floating panel 1200 using wires (not shown). The wire thickness is selected to provide sufficient tensile strength while exhibiting minimal compressive strength.

### FIGS. 15A 15B 15C 15D

FIGS. 15A 15B 15C 15D are cross-sectional top views of a portion of an example door 1000 according to the disclosure including example coupling spring 1450. FIG. 15A shows an example implementation in which coupling spring 1450 is attached at one end 1450a to anchoring panel 1200 via adhesive material 1600a. Coupling spring 1450 is attached at one end 1450b to floating panel 1300 via adhesive material 1600b.

FIG. 15B shows an example implementation in which coupling spring 1450 is attached at one end 1450a to anchoring panel 1200 via weld 1605a. Coupling spring 1450 is attached at one end 1450b to floating panel 1300 via weld 1605b.

FIG. 15C shows an example implementation in which coupling spring 1450 is attached at one end 1450a to anchoring panel 1200 via bolt 1610a. Coupling spring 1450 is attached at one end 1450b to floating panel 1300 via bolt 1610b.

15D shows an example implementation in which coupling spring 1450 is attached at one end 1450a to anchoring panel 1200 via press-fit pin 1615a. Coupling spring 1450 is attached at one end 1450b to floating panel 1300 via press-fit pin 1615b.

I claim:

1. A closure for closing an opening in a structure, comprising:
a first panel;
a second panel; and
an elastic coupler disposed between and configured to elastically couple the first panel to the second panel;
wherein the first panel, the second panel, and the elastic coupler are cooperatively configured to provide the second panel with at least one degree of freedom of movement relative to the first panel, such that, when an impact force is applied to the second panel while the closure is installed in the opening, the second panel moves relative to the first panel by elastic deformation of the elastic coupler, and wherein the elastic deformation absorbs at least a portion of the impact force.

2. The closure of claim 1, wherein the elastic coupler is configured to apply a restoration force to return the second panel toward a pre-impact position after reduction or removal of the impact force.

3. The closure of claim 2, wherein at least one of the first panel and the second panel includes one or more movement-limiting features configured to limit movement of the second panel away from the first panel during restoration.

4. The closure of claim 3, wherein the movement-limiting features are selected from the group consisting of stops, abutment surfaces, flanges, protrusions, recesses, tethers, cables, wires, straps, interlocking geometries, or compliant limiters.

5. The closure of claim 1, wherein the first panel is configured to be anchored on at least one side to the structure such that the first panel has at least one degree of freedom of movement relative to the structure when the opening is not closed.

6. The closure of claim 5, further comprising a latching body mounted to the first panel and configured to engage a latch-engaging side of the opening.

7. The closure of claim 6, wherein engagement of the latching body restrains movement of the first panel relative to the structure when the closure is installed.

8. The closure of claim 1, further comprising:
a third panel rigidly coupled to the second panel such that the second panel and the third panel move together as a unit;
wherein the elastic coupler is disposed between the first panel and one of the second panel and the third panel;
wherein, in response to an impact force applied to either the second panel or the third panel, the unit moves relative to the first panel by elastic deformation of the elastic coupler.

9. The closure of claim 8, optionally comprising:
a second elastic coupler disposed between the first panel and the other one of the second panel and the third panel;
wherein, in response to an impact force applied to either the second panel or the third panel, the unit moves relative to the first panel by elastic deformation of the elastic couplers.

10. The closure of claim 1, wherein the elastic coupler comprises one or more of:
(a) an elastic panel having a first side adhered to an interior surface of the first panel and a second side adhered to an interior surface of the second panel, and
(b) a plurality of springs having respective first ends affixed to the first panel and respective second ends affixed to the second panel.

11. A method for closing an opening in a structure, comprising:
providing a first panel;
elastically coupling a second panel to the first panel by an elastic coupler disposed between the first panel and the second panel; and
closing the opening with the first panel, the second panel, and the elastic coupler,
wherein a cooperative arrangement of the first panel, the second panel and the elastic coupler provides the second panel with at least one degree of freedom of movement relative to the first panel such that, when an impact force is applied to the second panel while the opening is closed, the second panel moves relative to the first panel by elastically deforming the elastic coupler, thereby absorbing at least a portion of the impact force.

12. The method of claim 11, further comprising returning the second panel to a pre-impact position by elastic recovery of the elastic coupler after the impact force is reduced or removed.

13. The method of claim 12, further comprising limiting movement of the second panel away from the first panel during restoration, using one or more movement-limiting features formed on at least one of the first panel and the second panel.

14. The method of claim 13, wherein the movement-limiting features are selected from the group consisting of stops, abutment surfaces, flanges, protrusions, recesses, tethers, cables, wires, straps, interlocking geometries, or compliant limiters.

15. The method of claim 11, further comprising anchoring the first panel to the structure on at least one side, such that the first panel has at least one degree of freedom of movement relative to the structure prior to closing the opening.

16. The method of claim 15, further comprising mounting a latching body to a side of the first panel and positioning the latching body to engage with a latch-engaging side of the opening when the closure is installed.

17. The method of claim 16, further comprising engaging the latching body with the latch-engaging side of the opening to restrain movement of the first panel relative to the structure when the opening is closed.

18. The method of claim 11, further comprising:
coupling a third panel rigidly to the second panel such that the second panel and the third panel move together as a unit,
elastically coupling the first panel to one of the second panel and the third panel using the elastic coupler;
wherein, in response to an impact force applied to either the second panel or the third panel, the unit moves relative to the first panel by elastic deformation of the elastic coupler.

19. The method of claim 18, optionally comprising:
elastically coupling the first panel and the other one of the second panel and the third panel using a second elastic coupler,
wherein, in response to an impact force applied to either the second panel or the third panel, the unit moves relative to the first panel by elastic deformation of the elastic couplers.

20. The method of claim 11, wherein elastically coupling the second panel to the first panel comprises one or more of:
(a) adhering a first side of an elastic panel to an interior surface of the first panel and adhering a second side of the elastic panel to an interior surface of the second panel, and
(b) affixing respective first ends of a plurality of springs to the first panel and respective second ends of the plurality of springs to the second panel.
